(19) United States
(12) Patent Application Publication
(10) Pub. No.: US 2005/0277317 A1
(43) Pub. Date: Dec. 15, 2005

(54) Micro coaxial connector having drawing device

(75) Inventor: Yu-Chi Peng, Jhongli City (TW)

Correspondence Address: Troxell Law Office Pllc, Suite 1404, 5205 Leesburg Pike, Falls Church, VA, 22041, US

(73) Assignee: Speed Tech Corp.

(21) Appl. No.: 10/863,223

(22) Filed: Jun. 9, 2004

(51) Int. Cl. H01R 12/00

(52) U.S. Cl. 439/157

(57) ABSTRACT

A micro coaxial wire having a drawing device includes a signal terminal, an insulating main body, a conducting body and a drawing device. The signal terminal clamping a coaxial wire is disposed in the insulating main body. The conducting body has a barrel section for accommodating the insulating main body, and external sections that can be bent toward the barrel section. The invention is characterized that, the barrel section is provided with a pivotal opening of each of two sides thereof. The drawing device is provided with protrusions to correspond with the pivotal openings. The protrusions are pivotally connected with the pivotal openings, such that a drawing space is formed between the drawing device and an upper portion of the connector. A user may place a finger or a tool having a pointed end at the drawing space to apply an upward force for pulling the drawing device.

### BACKGROUND OF THE INVENTION

(a) Field of the Invention

The invention relates to a micro coaxial connector having a drawing device and more particularly to a micro coaxial connector for overcoming drawbacks as being difficult to apply forces to an extremely small volume and being hard to disengage from a connector main body.

(b) Description of the Prior Art

Referring to FIGS. 1 and 2, a micro coaxial connector comprises a signal terminal 10, an insulating body 20 and a conducting body 30. The terminal 10 is a U-shaped body, and is relatively disposed at a bracket 11 made of a strip-like metal material, with a certain distance from the bracket 11. The terminal 10 has a soldering section 12, guide connecting sections 13, and a pillar 14 which is vertically provided at a front end thereof. The pillar 14 is pressed by a press plate 22 at a front end of the insulating body 20. The terminal 10 also has a pair of vertically disposed pillars 15 at a rear end thereof. Between the two pillars 15 is a notch 1 5A for placing a central conducting wire B1 of a coaxial wire B. By means of soldering, the central conducting wire B1 is fastened to the soldering section 12 of the terminal 10. The soldered terminal 10 is arranged in a seat recess 21 at the insulating body 20, placed in a seat tank 304 at a first conducting body 301 of the conducting body 30. Two conducting bodies 301 and 302 are a formed integral by stamping. A vertical connecting plane 303 connects the two conducting bodies 301, 302, such that the two conducting bodies 301 and 302 are formed as being perpendicular to each other. After completing the assembling the aforesaid structure, using a precision apparatus, the vertical second conducting body 302 is bent toward the first conducting body 301. A front arm 305, a middle arm 306 and a rear arm 307 are pressed to the first conducting body 301 and the coaxial wire B in sequence.

From the abovementioned descriptions, the prior micro coaxial connector fulfills functions as a connector. However, a connector main body of the connector is soldered to a substrate, and strong adhering forces are present between the connector and the connector main body. Therefore, it is essential that a substantial upward force be applied upon the connector in order to disengage the connector from the connector main body. Yet, the micro coaxial connector has an extremely small volume, and applying forces for withdrawing the connector are made relatively difficult. In worse cases, breakages and damages of the connector and the coaxial wire are likely caused by inappropriate drawing forces imposed upon the coaxial wire, with possibilities that circuits on the substrate being scratched. Hence, it is vital that the prior invention is to be advanced.

### SUMMARY OF THE INVENTION

In the view of the aforesaid drawbacks, the primary object of the invention is to provide a micro coaxial connector having a drawing device. By using the drawing device, we can solve the problems of the prior art which are difficult to apply forces for having an extremely small volume utilized on existing products as being hard to disengage from a connector main body thereby enhancing industrial practicability of the micro coaxial connector.

The invention comprises a signal terminal, an insulating main body, a conducting body and a drawing device. The signal terminal clamping a coaxial wire is disposed in the insulating main body. The conducting body has a barrel section for accommodating the insulating main body, and external sections that can be bent toward the barrel section. The invention is characterized that, the barrel section is provided with a pivotal opening at an appropriate position of each of two sides thereof. The drawing device is provided with protrusions at ends thereof in order to correspond with the pivotal openings. The protrusions are pivotally connected with the pivotal openings, such that a drawing space is formed between the drawing device and an upper portion of the connector. A user may place a finger or a tool having a pointed end into the drawing space to apply an upward force for pulling the drawing device without causing damages of the connector, the coaxial wire and the substrate from inappropriate forces.

### BRIEF DESCRIPTION OF THE DRAWINGS

FIG. 1 shows an exploded elevation view of a prior invention.

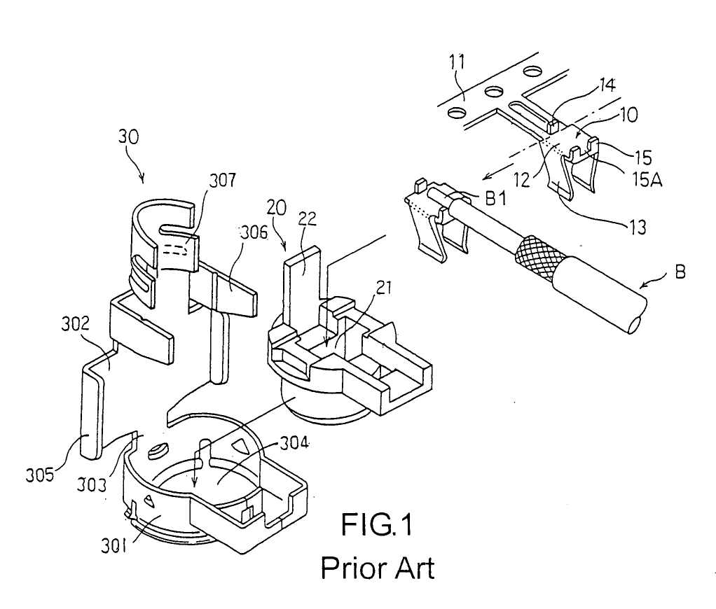

FIG. 2 shows a sectional schematic view of a prior invention.

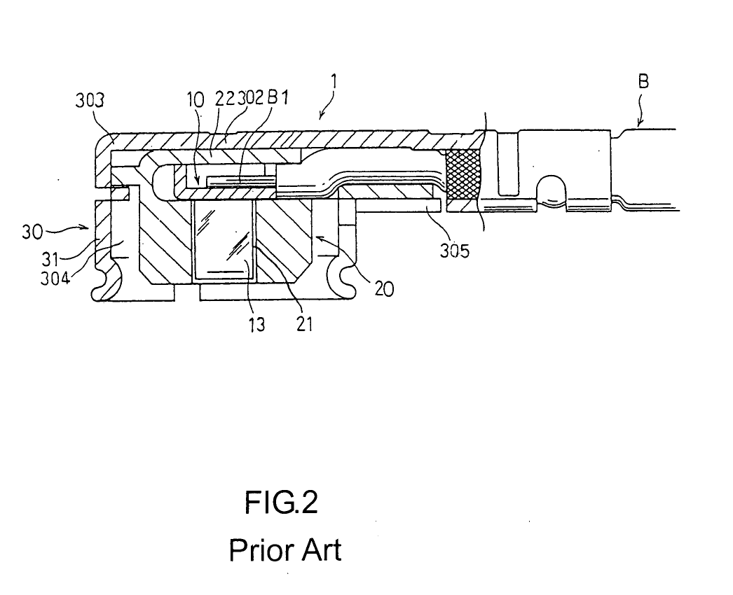

FIG. 3 shows a side schematic view according to the invention.

FIG. 4 shows a sectional schematic view according to the invention.

FIG. 5 shows an embodiment of the drawing device according to the invention.

FIG. 6 shows a schematic view of the drawing device in another shape according to the invention.

FIG. 7 shows a schematic view illustrating swinging movements of the drawing device according to the invention.

FIG. 8 shows a sectional schematic view of another embodiment according to the invention.

FIG. 9 shows a side schematic view of another embodiment according to the invention.

FIG. 10 shows a schematic view illustrating swinging movements in specific directions of the drawing device according to the invention.

FIG. 11 shows a schematic view illustrating swinging movements in specific directions of the drawing device in another embodiment according to the invention.

### DETAILED DESCRIPTION OF THE PREFERRED EMBODIMENTS

To better understand the object, characteristics and functions of the invention, detailed descriptions of preferred embodiments shall be given with the accompanying drawings below.

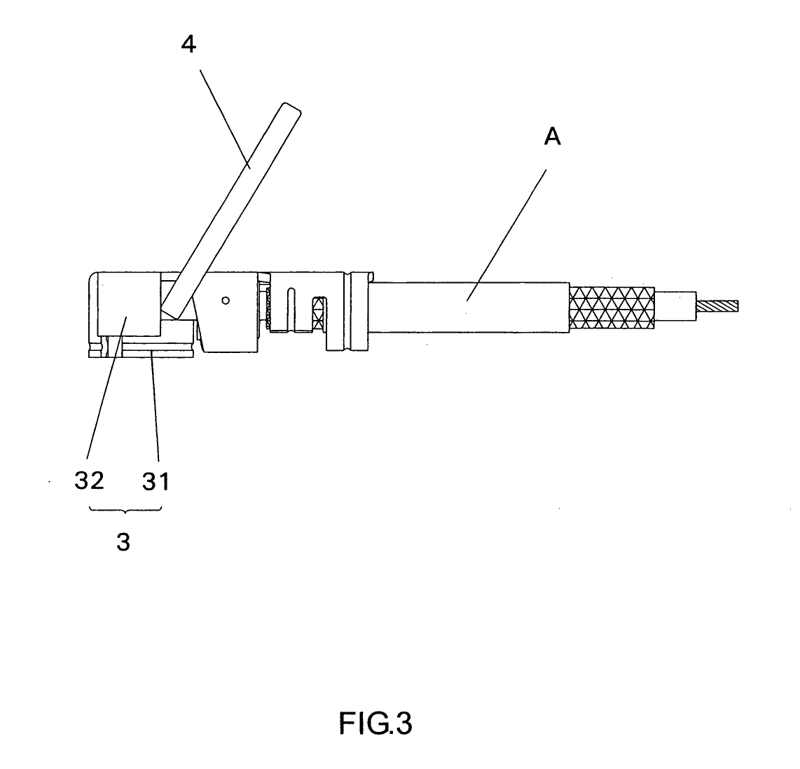

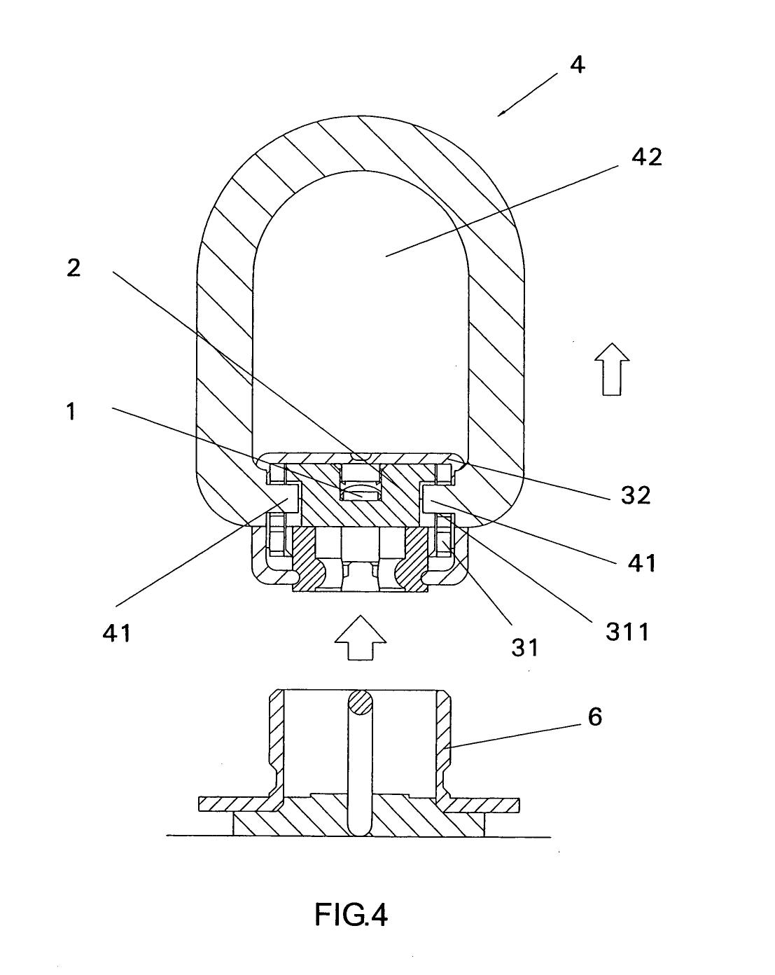

Referring to FIGS. 3 and 4 showing a structure according to the invention for overcoming drawbacks as being difficult to apply forces for having an extremely small volume, and being easily disengaged from a connector main body, the structure comprises a signal terminal 1, an insulating main body 2, a conducting body 3 and a drawing device 4. The signal terminal 1 clamping a coaxial wire A is disposed in the insulating main body 2. The conducting body 3 has a barrel section 31 for accommodating the insulating main body 2, and external sections 32 that can be bent toward the barrel section 31. The barrel section 31 is provided with a pivotal opening 311 at an appropriate position of each of two sides thereof. The drawing device 4 is provided with protrusions 41 at ends thereof in order to correspond with the pivotal openings 311. The protrusions 41 are pivotally connected with the pivotal openings 311, such that a drawing space 42 is formed between the drawing device 4 and an upper portion of the connector. A user may place a finger or a tool having a pointed end into the drawing space 42 to apply an upward force for pulling the drawing device 4.

According to the above descriptions, when disengaging the connector from the connector main body 6 soldered to a substrate, a finger or a tool having a pointed end is placed at the drawing space 42 of the drawing device 4 to further pull the drawing device 4 in an upward direction. Thus, an evenly distributed force is applied upon the conductor 3, so as to have the connector originally embedded in the connector main body 6 steadily withdrawn, thereby disengaging the connector from the connector main body 6 without damaging the connector and the coaxial wire.

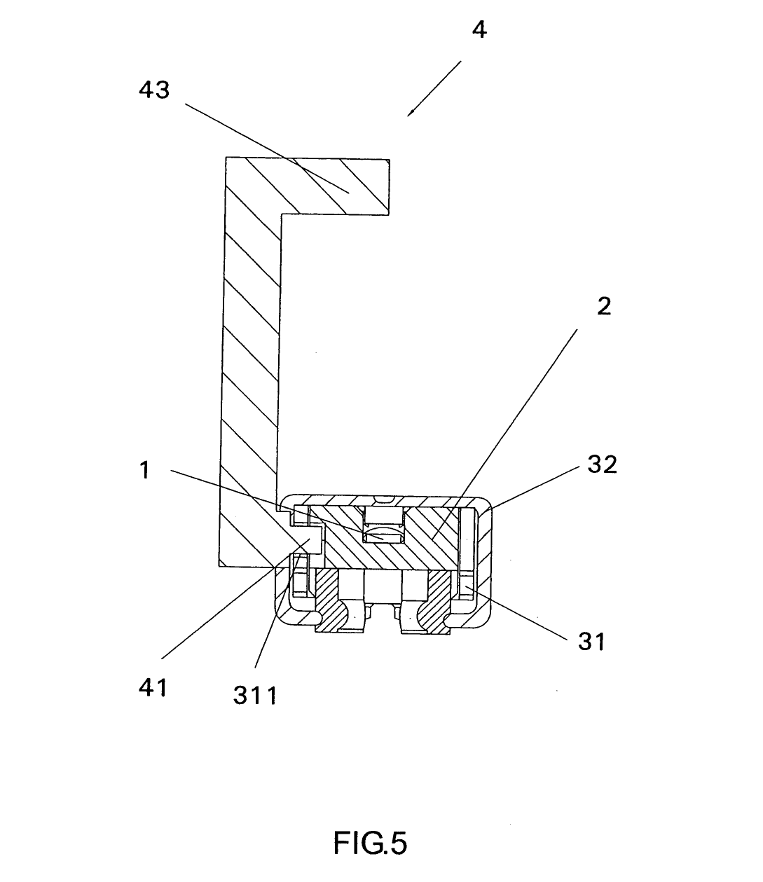

Referring to FIG. 5 showing an embodiment of the drawing device according to the invention, a pivotal opening 31 is disposed at an appropriate position at one side of a barrel section 31 of a conducting body 3, and is for inserting a drawing device 4 having a protrusion 41 at one end. The drawing device 4 is formed with a force application section 43 at the other end thereof. Using a finger or a tool having a pointed end in conjunction with the force application section 43, a user is able to pull the drawing device 4 in an upward direction to evenly apply a force upon the conducting body 3, thereby steadily withdrawing a connector originally embedded in a connector main body.

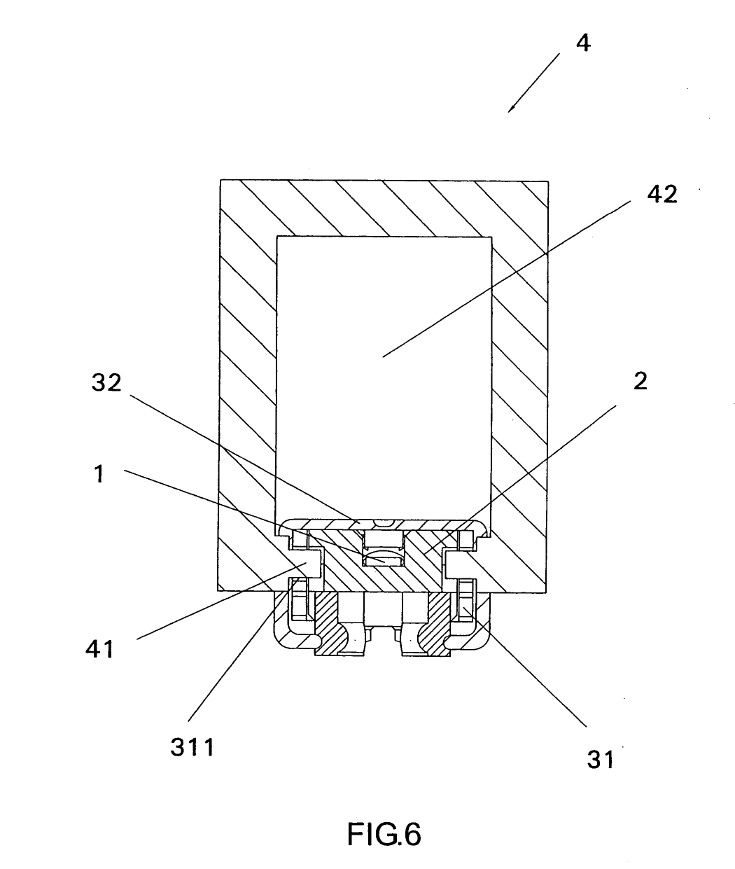

Referring to FIG. 6, the drawing device 4 may be provided as a loop in a circular, square and oval or ring shape that can be withdrawn. The drawing device 4 may be made of materials such as iron alloys, copper alloys, plastic, rubber and flexible wires that can withstand pulling forces.

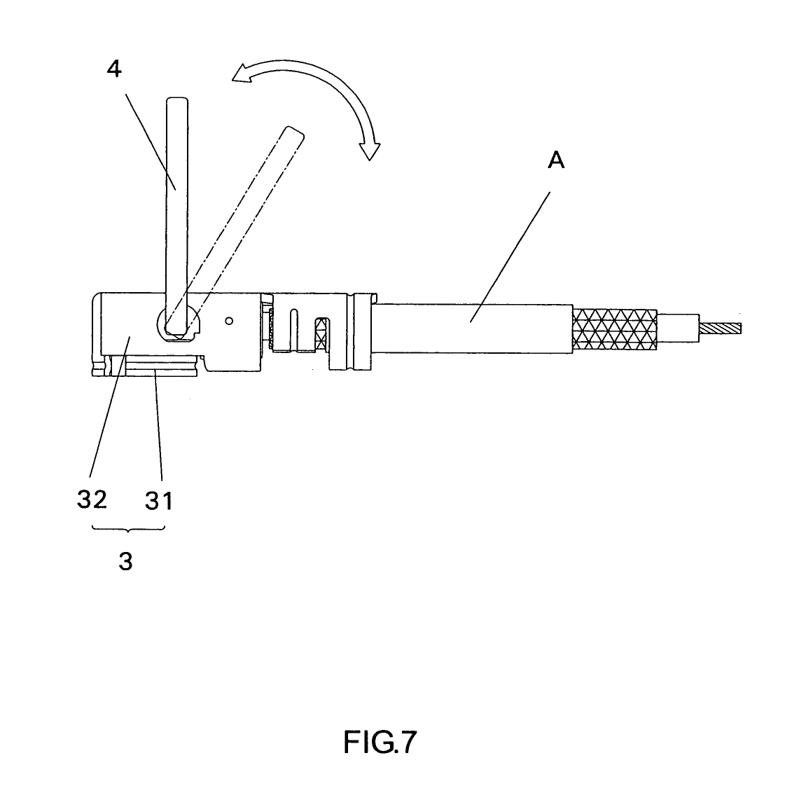

Referring to FIG. 7, the drawing device 4 is capable of left-and-right movements, and may be pressed downward to levelly adhere to the connector when not in use. Hence, the drawing device 4 not only occupies minimum space for offering convenience but also has an appealing appearance.

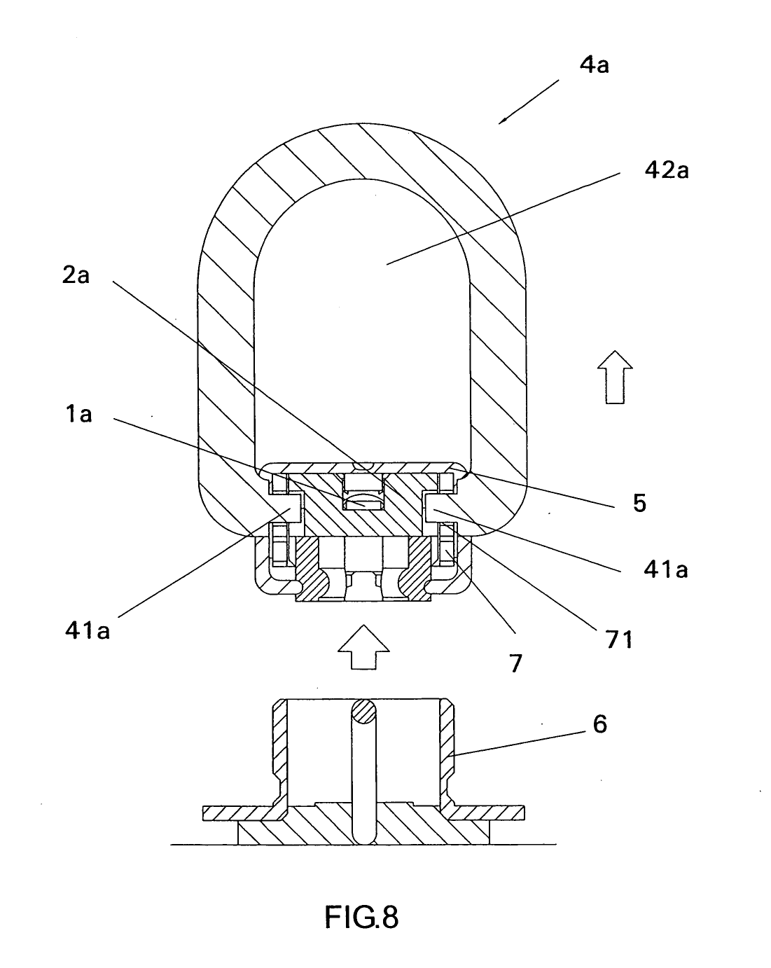

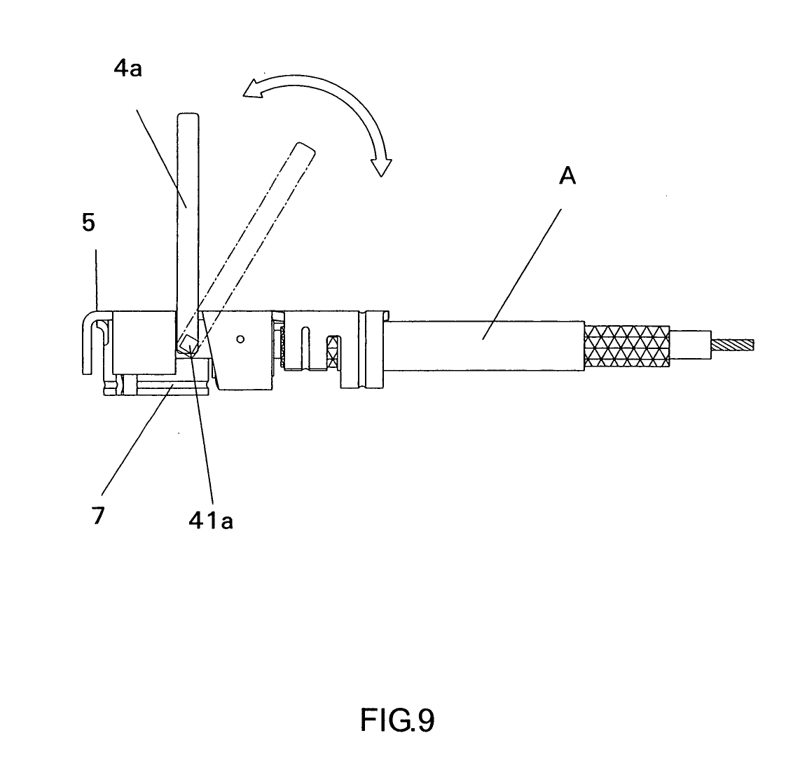

Referring to FIGS. 8 and 9 showing schematic view of another embodiment according to the invention, the invention comprises a signal terminal 1a, an insulating main body 2a, an external conducting body 7, a drawing device 4a and a cover body 5. The signal terminal 1a is for clamping a coaxial wire A and is accommodated in the insulating main body 2a. The insulating main body 2a is accommodated in the external conducting body 7. The cover body 5 is clamped and covered on the external conducting body 7 and the coaxial A. The external conducting body 7 is provided with a pivotal opening 71 at an appropriate position at each of two sides thereof. The drawing device 4a is provided with protrusions 41a at ends thereof in order to correspond with the pivotal openings 71. The protrusions 41a are pivotally connected with the pivotal openings 71, such that a drawing space 42a is formed between the drawing device 4a and an upper portion of the connector. A user may place a finger or a tool having a pointed end at the drawing space 42a withdrawing the entire connector from a connector main body 6.

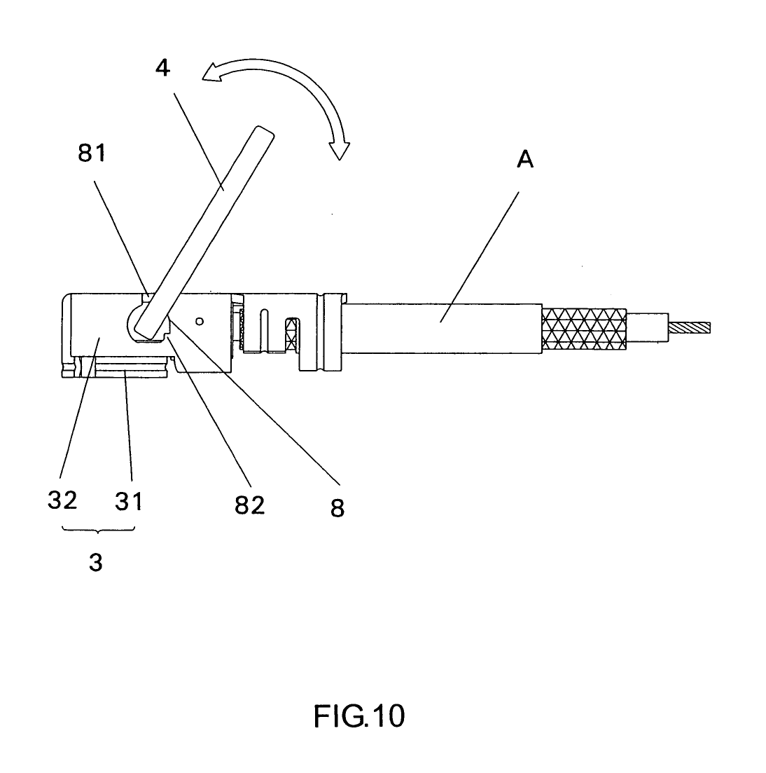

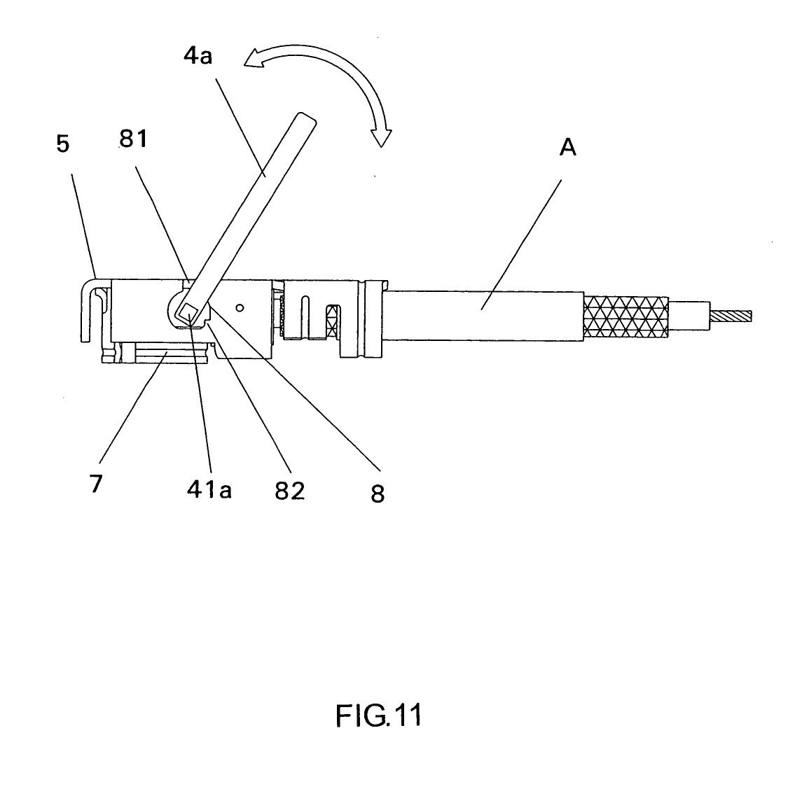

Referring to FIGS. 10 and 11, an external section 32 of the conducting section 3 and the cover 5 may be additionally provided with a hole 8 corresponding with the pivotal openings 311 and 71. The hole 8 has a protrusion 81 at an appropriate position at an upper portion thereof and a projecting corner 82 at an appropriate position at a lower portion thereof. The protrusion 81 and the projecting corner 82 are for retaining the drawing devices 4 and 4a to perform swinging movements in specific directions within an appropriate angle, thereby preventing the drawing devices 4 and 4a from disorderly back-and-forth swinging movements.

Conclusive from the above, the invention has the following excellences:

1. Using the drawing device, the connector is steadily withdrawn to disengage the connector from the connector main body. Apart from offering facilitated assembly, the drawing device prevents damages of the circuits on the substrate, the connector or the coaxial wire.

2. Through left-and-right swinging movements of the drawing device, the drawing device may be bent downward to levelly adhere to the connector, thereby occupying minimum space for convenience as well as providing an appealing appearance.

3. Using the protrusion and the projecting corner, the drawing device performs only swinging movements in specific directions within an appropriate angle, thereby preventing the drawing devices 4 and 4a from disorderly back-and-forth swinging movements.

The micro coaxial connector having a drawing device according to the invention, using the drawing device, offers a simple procedure for disengaging a connector from a connector main body. It is of course to be understood that the embodiments described herein are merely illustrative of the principles of the invention and that a wide variety of modifications thereto may be effected by persons skilled in the art without departing from the spirit and scope of the invention as set forth in the following claims.

1. A micro coaxial connector having a drawing device, comprising a signal terminal, an insulating main body, a conducting body and a drawing device; wherein, the signal terminal clamping a coaxial wire is disposed in the insulating main body; the conducting body has a barrel section for accommodating the insulating main body, and external sections that can be bent toward the barrel section; the barrel section is provided with at least one pivotal opening at an appropriate position at sides thereof; the drawing device is provided with protrusions at ends thereof in order to correspond with the pivotal openings; and the protrusions are pivotally connected with the pivotal openings, such that a drawing space is formed between the drawing device and an upper portion of the connector.

2. The micro coaxial connector having a drawing device in accordance with claim 1, wherein the drawing device is provided as a loop in a circular, square oval or ring shape that can be drawn.

3. The micro coaxial connector having a drawing device in accordance with claim 1, wherein the drawing device is made of materials such as iron alloys, copper alloys, plastic, rubber or flexible wires that can withstand pulling forces.

4. The micro coaxial connector having a drawing device in accordance with claim 1, wherein external sections of the conducting section are additionally provided with a hole corresponding with the pivotal openings; the hole has a protrusion at an appropriate position at an upper portion thereof and a projecting corner at an appropriate position at a lower portion thereof; and the protrusion and the projecting corner are for retaining the drawing device to perform swinging movements in specific directions within an appropriate angle, thereby preventing the drawing device from disorderly back-and-forth swinging movements.

5. The micro coaxial connector having a drawing device in accordance with claim 1, wherein the drawing device is formed with a force application section at an end which is opposed to said protrusion.

6. A micro coaxial connector having a drawing device comprising a signal terminal for clamping a coaxial wire, an insulating main body composed of insulating material for accommodating said signal terminal, a conducting body for receiving said insulating main body therein having at least one pivotal opening; a cover body clamping and covering said signal terminal with said conducting body therein; a drawing device having a protrusion at one end corresponding with said pivotal opening thereby allowing a drawing space being formed between the drawing device and an upper portion of the connector.

7. The micro coaxial connector having a drawing device in accordance with claim 6, wherein the drawing device provided as a loop in a circular, square oval or ring shape that can be drawn.

8. The micro coaxial connector having a drawing device in accordance with claim 6, wherein the drawing device made of materials such as iron alloys, copper alloys, plastic, rubber or flexible wires that can withstand pulling forces.

9. The micro coaxial connector having a drawing device in accordance with claim 6, wherein the cover is additionally provided with a hole corresponding with the pivotal openings; the hole has a protrusion at an appropriate position at an upper portion thereof and a projecting corner at an appropriate position at a lower portion thereof; and the protrusion and the projecting corner are for retaining the drawing device to perform swinging movements in specific directions within an appropriate angle, thereby preventing the drawing device from disorderly back-and-forth swinging movements.
